(19) United States
(12) Patent Application Publication
(10) Pub. No.: US 2007/0239917 A1
(43) Pub. Date: Oct. 11, 2007

(54) Interrupt routing within multiple-processor system

(76) Inventors: Ryuji Orita, Redmond, WA (US); Mehul M. Shah, Austin, TX (US); Sumeet Kochar, Apex, NC (US)

Correspondence Address: LAW OFFICES OF MICHAEL DRYJA, 1474 N COOPER RD #105-248, GILBERT, AZ, 85233, US

(21) Appl. No.: 11/299,152

(22) Filed: Dec. 9, 2005

(51) Int. Cl. G06F 13/24

(52) U.S. Cl. 710/268

(57) ABSTRACT

Interrupts are routed within a multiple-processor system, such as a single computing device having multiple processors. Such a computerized system includes a number of processors and a mechanism. Each processor is capable of processing an interrupt. The mechanism, such as a Southbridge controller, receives the interrupt and routes it to a selected processor. The selected processor processes the interrupt via entry into a mode related to the interrupt. The interrupt may be a system management interrupt (SMI), and the mode a system management mode (SMM). The other processors operate normally and are not affected by processing of the interrupt, and do not have to enter the mode. These other processors can continue executing code as before, and may receive and process other types of interrupts. The system may include another mechanism, such as a complex programmable logic device (CPLD), specifying the selected processor.

### FIELD OF THE INVENTION

The present invention relates generally to multiple-processor systems, such as a computing device having multiple processors, and more particularly to routing an interrupt to a selected processor of such a multiple-processor system for processing, such that the other-processors operate normally and are not affected by interrupt processing.

### BACKGROUND OF THE INVENTION

Historically, computing devices each had a single processor. The processor is the computing mechanism of a computer, and is the component of the computer that executes the instructions of computer code of computer programs, in order for the computer to perform desired functionality. More recently, to increase performance, computing devices have been developed in which there are multiple processors.

An interrupt is a signal that interrupts a processor so that the event that caused an interrupt can be immediately processed by the processor, or such that the processor can become immediately aware of the event. For example, a processor may be executing computer code for an operating system (OS) or a computer program running on the OS. During such computer code execution, the processor may receive an interrupt. At that time, the processor may temporarily stop executing the computer code in question, in order to process the interrupt.

One type of interrupt is a system management interrupt (SMI). An SMI relates to a system management mode (SMM) of modem computerized system processor architectures, such as those of processors available from Intel Corp., of Santa Clara, Calif. The SMM is commonly used by processors for system management, including power management, error handling of memory and input/output (I/0) devices, like peripheral component interconnect (PCI) devices, and other functions. When an SMI is received, a processor immediately processes the SMI using handler computer code within the firmware, such as the basic input/output system (BIOS) of the system in question. SMI's execute at higher priority than the operating system (OS) of the system, such that OS is temporarily halted while an SMI is being processed.

Within complex and large systems, SMI's are frequently generated. This is because there are a large number of memory and I/O devices within such systems, where a device can be an actual peripheral I/O device, as well as the bridge interconnecting such devices to the processors. Furthermore, SMI's can take a relatively long time to process within such systems, because there are a large number of devices that have to be examined in relation to a given error, for instance, represented by a given SMI.

Processing SMI's within such systems can be problematic, however. This is because while an SMI is being processed, a processor is unable to process other interrupts. The SMI has a higher priority than other interrupts have, such as timer interrupts, such that the SMI masks these other interrupts. This can cause problems when other such interrupts are delayed in their receipt, or completely not received, due to a processor currently processing an SMI.

For example, an OS may be expecting a periodic timer interrupt every millisecond. However, the timer delivery interrupt may be delayed or lost if the processor stays in SMM too long while processing an SMI. Timing-critical application computer programs or services running on the OS may thus operate unexpectedly, or even fail.

Furthermore, within a multiple-processor system, such as a computing device having multiple processors, when an SMI is received, all processors enter SMM. The SMM is thus a state or mode in which a processor enters in order to process an SMI. More generally, the SMM is a particular mode that a processor enters to process a particular interrupt, and in which normal processing by the processor, such as of computer code of the OS or a computer program, cannot be achieved.

All processors of a system enter SMM when an SMI is received because of shared PCI device resources between the firmware handler code for the SMI and the OS itself. For example, there is a PCI configuration registers memory space for a PCI device that includes a so-called CF8 index register and a CFC data register. A processor that receives an SMI in relation to this device uses these CF8 and CFC registers to process the SMI. However, the CF8 and CFC registers are-also employed by computer code of the OS to normally access the PCI device.

Therefore, in this situation, all processors of a system enter SMM when an SMI is received so that there are no conflicts on the CF8 and CFC registers for each PCI device. That is, while just one processor may in actuality process the SMI, the other processors nevertheless enter SMM so that they do not execute computer code of the OS that may try to access the CF8 and CFC registers while the processor processing the SMI accesses the CF8 and CFC registers. However, while these other processors are in SMM, they are effectively halted, and cannot execute computer code of the OS or another computer program until they exit SMM.

Furthermore, these other processors that are in SMM but not actively processing the SMI themselves cannot receive other interrupts, such as timer interrupts, while in SMM. Thus, as described above, such timer interrupts may become undesirably delayed, or even lost—even though there are processors available for processing them. For this and other reasons, therefore, there is a need for the present invention.

### SUMMARY OF THE INVENTION

The present invention relates to routing interrupts within a multiple-processor system, such as a single computing device having multiple processors. Such a computerized system of one embodiment of the invention includes a number of processors and a mechanism. Each processor is capable of processing an interrupt. The mechanism, which may be a Southbridge controller, is to receive the interrupt and route the interrupt to a selected processor for processing. The selected processor processes the interrupt via entry into a mode related to the interrupt. The interrupt may be a system management interrupt (SMI), for instance, such that this mode is the system management mode (SMM). The other processors operate normally and are not affected by processing of the interrupt, and do not have to enter the mode related to the interrupt.

A method of an embodiment of the invention includes receiving an interrupt, and routing the interrupt to a selected processor of a number of processors. The selected processor enters a mode related to the interrupt, and processes the interrupt within the mode. Thus, processors other than the selected processor operate normally without being affected by processing of the interrupt, and without having to enter the mode.

An article of manufacture of an embodiment of the invention includes a tangible computer-readable medium and means in the medium. The tangible computer-readable medium may be a semiconductor medium, such as a Southbridge controller, for instance, or another type of tangible computer-readable medium. The means is for routing an interrupt to a selected processor of a number of processors. The selected processor processes the interrupt upon entry into a mode related to the interrupt. The other processors operate normally, without being affected by interrupt processing and without having to enter the mode themselves.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of a computerized system, according to a preferred embodiment of the invention, and is suggested for printing on the first page of the patent.

FIG. 2 is a diagram of a computerized system that is more detailed than but consistent with the computerized system of FIG. 1, according to an embodiment of the invention.

FIG. 3 is a flowchart of a method, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and-other changes may be made without departing from the spirit or scope of the present invention. The following detailed description is, therefore, not to be taken in a limiting sense, and the scope of the present invention is defined only by the appended claims.

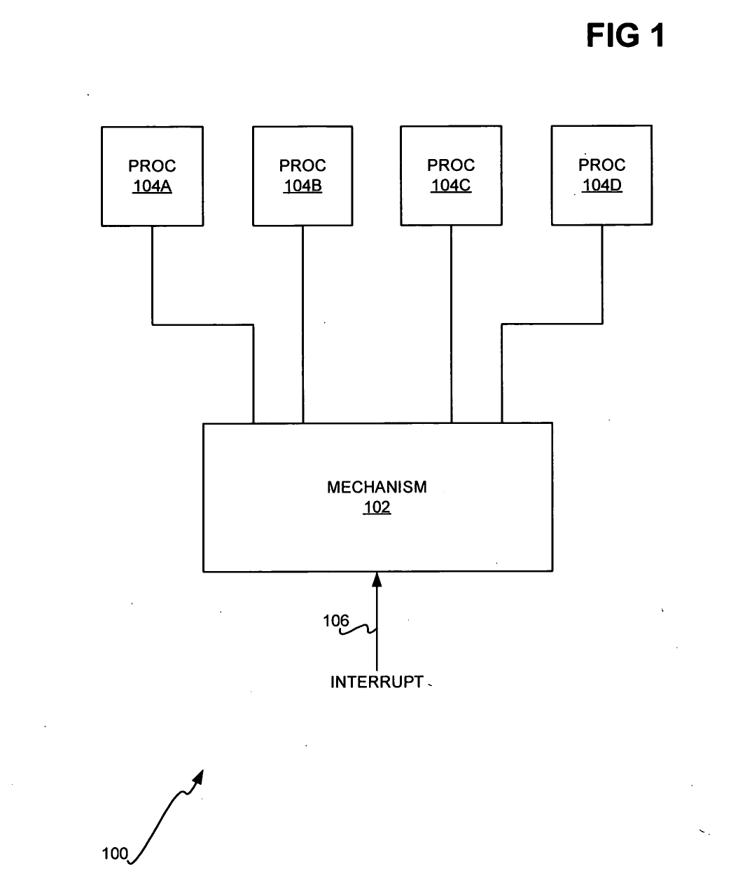

Overview FIG. 1 shows a computerized system 100, according to an embodiment of the invention. The system 100 may be implemented as a single computing device in one embodiment. The system 100 is depicted in FIG. 1 as including a mechanism 102, and a number of processors 104A, 104B, 104C, and 104D, collectively referred to as the processors 104. As can be appreciated by those of ordinary skill within the art, the system 100 can and typically will have additional components, besides those depicted in FIG. 1. Furthermore, whereas there are four processors 104 shown in FIG. 1, in other embodiments of the invention there may fewer or more of such processors 104, including as few as two processors 104.

The mechanism 102 may be implemented in hardware, and in one embodiment is or is part of what is known within the art as a Southbridge controller. The mechanism 102 receives an interrupt, as indicated by the arrow 106. This signal may be a source of a particular kind of interrupt known within the art as a system management interrupt (SMI). The mechanism 102 routes the interrupt to a selected processor of the processors 104, for processing of the interrupt, even though all the processors 104 are capable of processing the interrupt in question.

The selected processor processes the interrupt by first entering a mode in which normal processing is suspended or halted. For instance, where the interrupt is an SMI, the selected processor may enter a system management mode (SMM). While in SMM, the selected processor is unable to execute other computer code, such as operating system (OS) computer code, and application computer program computer code. Furthermore, while in SMM, the selected processor is unable to receive and processor other types of interrupts, such as timer and device interrupts.

However, while the selected processor is in the mode in which normal processing is suspended or halted, as noted in the previous paragraph, and is thus processing the interrupt, the other processors of the processors 104 function and operate normally, without being affected by processing of the interrupt. In particular, these other processors do not and do not have to enter the mode in which normal processing is suspended or halted, while the selected processor is in the mode and processing the interrupt. These other processors can continue executing other computer code, such as OS computer code and application computer program computer code, as before. Furthermore, these other processors can receive and processor other interrupts, such as timer and device interrupts, while the selected processor is processing its interrupt. As such, other types of interrupts are not delayed or even lost while the selected processor processes an SMI, for instance.

Technical Background and Detailed System

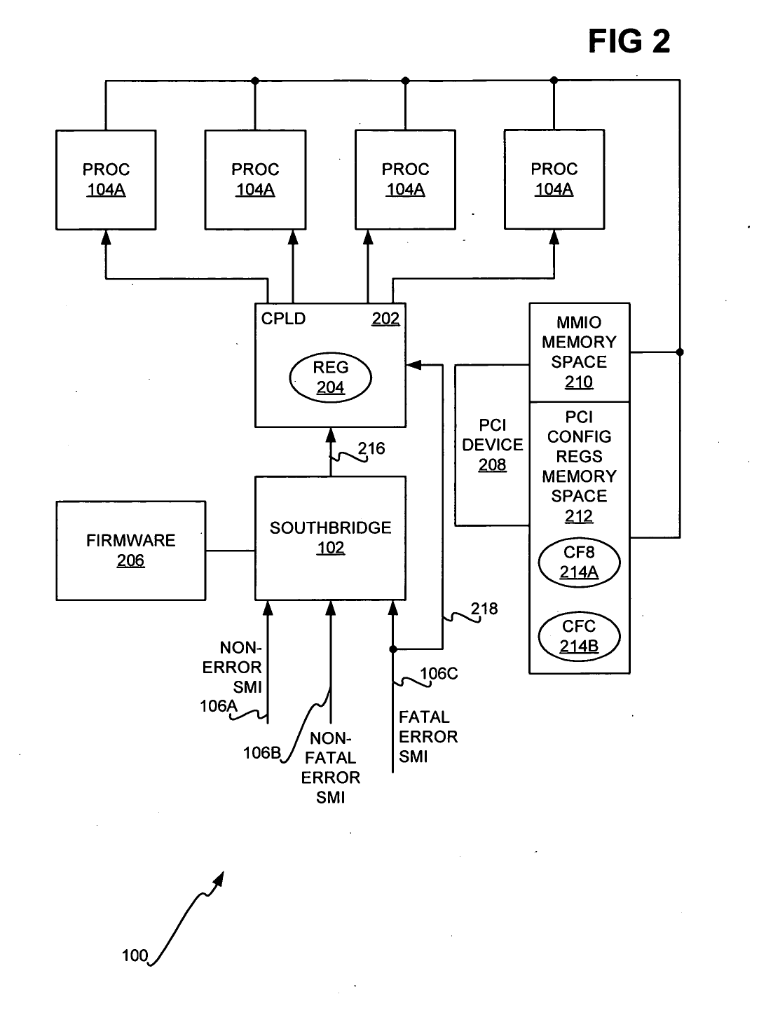

FIG. 2 shows the computerized system 100 in more detail than, but consistent with, FIG. 1, according to an embodiment of the invention. As before, the system 100 may be implemented as a single computing device, and includes the mechanism 102, specifically referred to as the Southbridge controller in FIG. 2, and the processors 104. The system 100 also is depicted in FIG. 2 as including another mechanism 202, specifically referred to as a complex programmable logic device (CPLD) in FIG. 2, and firmware 206, such as a basic input/output system (BIOS). The system 100 also is shown in FIG. 2 as including a peripheral component interconnect (PCI) device 208, having a memory-mapped input/output (MMIO) memory space 210, and a PCI configuration registers memory space 212. In one embodiment, the device 208 may be a memory controller, instead of a PCI device, where the terminology “device” encompasses a memory controller.

The arrow 106 indicating receipt of an interrupt by the mechanism 102 in FIG. 1 is delineated in FIG. 2 as three separate arrows 106A, 106B, and 106C, each representing receipt of a different type of system management interrupt (SMI) by the mechanism 102. The interrupts associated with the arrows 106A and 106B are a non-error SMI and a non-fatal error SMI, and these interrupts are handled the same way by the mechanism 102. A non-error SMI is an SMI that does not relate to an error, such as an error of a device like the PCI device 208. For instance, such a non-error SMI may be a power management-related SMI, as can be appreciated by those of ordinary skill within the art. A non-fatal error SMI is also known as a correctable or a recoverable error SMI. Such a non-fatal error SMI relates to an error on a device, such as the PCI device 208, that can be recovered from, or corrected.

When the mechanism 102 receives a non-error SMI or a non-fatal error SMI, as indicated by the arrows 106A and 106B, it sends the SMI to a particular port or pin of the mechanism 202, as indicated by the arrow 216. The mechanism 202, which can be implemented in hardware, particularly specifies the selected processor of the processors 104 that is to receive and process the interrupt. In one embodiment, the mechanism 202 may be implemented within a Northbridge controller, as can be appreciated by those of ordinary skill within the art. Furthermore, where the mechanism 202 is a CPLD, it has a register 204 that is programmed to specify this selected processor. Therefore, the mechanism 202 routes the non-error or non-fatal error SMI to the selected processor. It can thus be said that the mechanism 102 routes the interrupt to the selected processor specified within the mechanism 202.

As before, the selected processor processes the non-error or the non-fatal error SMI by entering a system management mode (SMM), which is more generally a mode associated with an interrupt and which has to be entered to process the interrupt. The selected processor particularly executes handler computer code stored in the firmware 206 in order to process the SMI. Once the SMI has been processed, the selected processor exits the SMM.

During processing of the non-error or the non-fatal error SMI by the selected processor, the other processors of the processors 104 operate normally, as before. That is, they continue executing operating system (OS) computer code or application computer program computer code. These other processors do not enter the SMM. Furthermore, these other processors can receive other types of interrupts, such as non-SMI interrupts like device and timer interrupts, and process them. Therefore, other interrupts are not delayed or lost within the system 100 while the selected processor is processing the SMI.

During processing of the SMI, the selected processor may determine that another processor of the processors 104 should continue processing the SMI. For instance, this other processor may have resources available to it that the selected processor does not, or this other processor may not be executing any other critical task, while the selected processor may have halted a critical task in order to process the SMI. Therefore, the selected processor may route the SMI to this other processor.

In one embodiment, the selected processor generates a particular type of interrupt, known as an inter-processor interrupt (IPI), to route the SMI to the other processor. In another embodiment, the selected processor may reprogram the mechanism 202 to route the SMI to the other processor. For instance, where the mechanism 202 is a CPLD, the register 204 initially is programmed to specify the selected processor. The selected processor can in turn reprogram the register 204 so that it instead specifies the other processor in question. Once the other processor has finished processing the SMI, the register 204 may be again reprogrammed so that it again specifies the selected processor.

As has been described, the mechanism 102 can receive non-error and non-fatal error SMI's, as indicated by the arrows 106A and 106B, as well as fatal error SMI's, as indicated by the arrow 106C. It is thus said that the mechanism 102 determines the type of SMI that has been received. Where this type of SMI is a non-error or a non-fatal error SMI, the mechanism 102 routes the SMI to a particular port or pin of the mechanism 202, as indicated by the arrow 216, so that just the selected processor of the processors 104 receives the SMI in question.

However, where this type of SMI is a fatal error SMI, as indicated by the arrow 106C, the SMI is routed to all the processors. In one embodiment, this is accomplished by the fatal error SMI automatically being routed to another pin or port of the mechanism 202, as indicated by the arrow 218. This causes the fatal error SMI to be routed to all the processors 104, by, through, or via the mechanism 202, such that they all enter the SMM. A fatal error SMI having to do with a particular device, such as the PCI device 208, is such that none of the processors 104 should potentially continue processing as to this device, and this is why they all enter the SMM. A fatal error is also referred to as an uncorrectable or an unrecoverable error.

Therefore, it can be said that the mechanism 102 determines the type of SMI that has been received, and where this type of SMI is a fatal error SMI, the mechanism 102 routes the SMI to all the processors 104. It is noted that in the embodiment of FIG. 2, the mechanism 102 does not route such a fatal error SMI to the mechanism 202 as indicated by the arrow 216, since it is known that a fatal error SMI has been automatically routed to the mechanism 202 by the arrow 218. It is further noted that in one embodiment, the mechanism 102 may include or subsume the functionality of the mechanism 202, such that the mechanism 202 may be a part of the mechanism 102, instead of apart from and different than the mechanism 102 as depicted in FIG. 2.

More generally, when an interrupt is received that is of a particular type, it is routed by the mechanism 102 to all the processors 104. For instance, the interrupt may be a fatal error SMI, as associated with the arrow 106C, such that the mechanism 102 is said to implicitly route this interrupt to all the processors 104 via the mechanism 202 as denoted by the arrow 218, by virtue of the mechanism 102 not routing the interrupt via the mechanism 202 as denoted by the arrow 216. When the interrupt is not of this particular type, it is routed by the mechanism 102 to a selected processor of the processors 104. For instance, the interrupt may be a non-error SMI or a non-fatal error SMI, as associated with the arrows 106A and 106B, such that the mechanism 102 explicitly routes this interrupt to the selected processor via the mechanism 202.

When the selected processor of the processors 104 is processing a non-error or a non-fatal error SMI after having entered the SMM, and where this SMI relates to the PCI device 208, the selected processor utilizes the MMIO memory space 210 of the device 208 to process the interrupt. This is in contradistinction to the prior art, in which SMI's relating to a PCI device are instead processed using a PCI configuration memory space including a CF8 index register and a CFC data register. Therefore, conflicts are avoided between processing an SMI that relates to the PCI device 208 and other processing that relates to or accesses the PCI device 208.

For instance, the other processors of the processors 104, when executing OS or other computer code that accesses the PCI device 208, utilize the CF8 index register 214A and the CFC data register 214B of the PCI configuration registers memory space 212 of the PCI device 208. That is, the OS accesses the PCI device 208 utilizing the CF8 register 214A and the CFC register 214B, collectively referred to as the registers 214. Such access of the PCI device 208 utilizing the registers 214 is conventional. Therefore, embodiments of the invention avoid conflict with such executing OS or other computer code on the other processors not by having these other processors also enter the SMM along with the selected processor, but rather by the selected processor using the MMIO memory space 210 to access the device 208, instead of the registers 214. As a result, the other processors can continue accessing the PCI device 208 via the registers 214, and the selected processor can access the device 208 during processing of an SMI related to the device 208 at the same time, via the MMIO memory space 210, without conflict.

Method and Conclusion

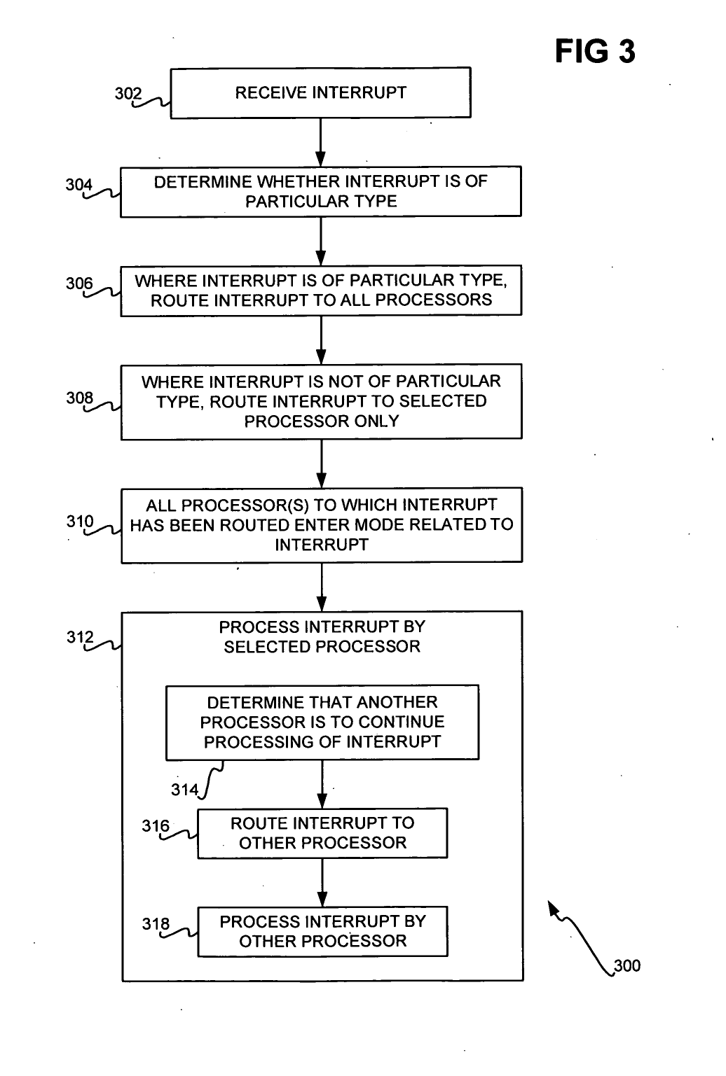

FIG. 3 shows a method 300, according to an embodiment of the invention. The method 300 is for processing an interrupt within a multiple-processor system, such as the system 100 that has been described. An interrupt is first received (302), such as by the mechanism 102. The mechanism 102 may implicitly or explicitly determine whether the interrupt is of a particular type (304). For instance, it may be determined whether the interrupt, which is a system management interrupt (SMI) is a fatal error SMI, an SMI that does not represent a fatal error, such as a non-fatal error SMI, or a non-error SMI.

Where the interrupt is of the particular type, it is routed to all the processors 104 (306). For instance, the mechanism 102 may implicitly, explicitly, or inherently route a fatal error SMI to all the processors 104, as has been described. However, where the interrupt is not of the particular type, it is routed to just a selected processor of the processors 104 (308). For instance, the mechanism 102 may route a non-fatal error SMI or a non-error SMI to the selected processor via the mechanism 202, by routing the SMI in question to the mechanism 202, which then routes it to the selected processor.

All the processor(s) to which the interrupt has been routed enter a mode associated with or related to the interrupt (310), where entry into this mode is needed in order to process the interrupt. For instance, in relation to an SMI, the mode in question is the system management mode (SMM). Where the SMI is a fatal error SMI, then all the processors enter SMM, even though only one of the processors—for instance, the selected processor—may actually process the SMI. Where the SMI is a non-fatal error SMI or a non-error SMI, then just the selected processor enters SMM, and the other processors operate normally, as has been described, such that they may receive and process other types of interrupts, like non-SMI device and timer interrupts.

The selected processor thus processes the interrupt (312). In one embodiment, this may include the selected processor determining, at some point within its processing of the interrupt, that another processor should continue processing of the interrupt (314). In such instance, the selected processor routes the interrupt to the other processor (316), such as by sending a inter-processor interrupt (IPI), or by reprogramming the register 204 of the mechanism 202 where the mechanism 202 is a CPLD, and/or where the register 204 specifies which processor receives the interrupt. This other processor then continues processing the interrupt (318).

It is noted that the method 300 can be implemented as one or more computer programs, which can constitute a means, stored on a tangible computer-readable medium of an article of manufacture. The medium may be a recordable data storage medium, for instance. Thus, the computer programs, or means, stored on this medium are for routing an interrupt to a selected processor of a plurality of processors for processing by the selected processor upon entry into a mode related to the interrupt. As a result, the processors other than the selected processor operate normally without being affected by the selected processor processing the interrupt and without having to enter the mode. The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

For instance, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

Embodiments of the invention provide for advantages over the prior art. When an SMI is received, for instance, only one processor has to enter an SMM to process the SMI. The other processors do enter the SMM, and therefore operate normally, executing OS or another type of computer code as before. Furthermore, these other processors are capable of receiving and processing other types of interrupts, such as timer interrupts, while the selected processor is processing the SMI. Therefore, delivery of interrupts is not delayed, nor are interrupts lost.

In one embodiment of the invention, conflicts between processing of an SMI relating to a PCI device and other processing relating to the same PCI device are avoided by having the SMI processed using an MMIO memory space, in lieu of a PCI configuration registers memory space including the CF8 and CFC registers. Thus, the other processing relating to the PCI device can continue using the CF8 and CFC registers, as before, without the potential for such processing affecting processing of the SMI, since processing of the SMI does not use these registers.

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Therefore, it is manifestly intended that this invention be limited only by the claims and equivalents thereof.

We claim:

1. A computerized system comprising:
a plurality of processors, each processor capable of processing an interrupt; and,
a mechanism to receive the interrupt and route the interrupt to a selected processor of the processors for processing via entry of the selected processor into a mode related to the interrupt,
wherein the processors other than the selected processor to which the interrupt is routed operate normally without being affected by processing of the interrupt, and without having to enter the mode related to the interrupt.

2. The computerized system of claim 1, wherein at least one of the processors other than the selected processor receives and processes another interrupt having a different type, while the selected processor is in the mode and processes the interrupt.

3. The computerized system of claim 1, further comprising another mechanism specifying the selected processor to which the interrupt is to be routed.

4. The computerized system of claim 3, wherein the other mechanism is a complex programmable logic device (CPLD) having a register specifying the selected processor to which the interrupt is to be routed.

5. The computerized system of claim 1, wherein the mechanism is further to determine whether the interrupt is a particular type of interrupt, such that the interrupt is routed to the selected processor where the interrupt is a type other than the particular type of interrupt.

6. The computerized system of claim 5, wherein the mechanism is to route the interrupt to all the processors where the interrupt is the particular type.

7. The computerized system of claim 1, wherein the mechanism is a Southbridge controller.

8. The computerized system of claim 1, wherein the interrupt is a system management interrupt (SMI), and the mode is a system management mode (SMM).

9. The computerized system of claim 1, wherein the selected processor, during processing of the interrupt, determines that another of the processors is to continue processing of the interrupt, such that the selected processor routes the interrupt to the other of the processors.

10. The computerized system of claim 9, wherein the selected processor sends an inter-processor interrupt (IPI) to the other processor to route the interrupt to the other processor.

11. The computerized system of claim 9, wherein the selected processor programs another mechanism previously specifying the selected processor to which the interrupt is to be routed in order to route the interrupt to the other processor.

12. The computerized system of claim 1, further comprising computer code executed by the selected processor to process the interrupt.

13. The computerized system of claim 12, wherein, where the interrupt relates to a peripheral component interconnect (PCI) device, the selected processor utilizes a memory-mapped input/output (MMIO) memory space for the PCI device during processing of the interrupt to access the PCI device.

14. The computerized system of claim 13, wherein at least one of the other processors executes operating system (OS) code accessing PCI configuration registers memory space for the PCI device while the selected processor is processing the interrupt, such that accessing the PCI configuration registers memory space by the OS code is unaffected by the selected processor utilizing the MMIO memory space.

15. The computerized system of claim 14, wherein the PCI configuration registers memory space comprises a CF8 index register and a CFC data register.

16. The computerized system of claim 1, wherein the computerized system is implemented as a single computing device.

17. A method comprising:
receiving an interrupt;
routing the interrupt to a selected processor of a plurality of processors;
entering a mode related to the interrupt by the selected processor; and,
processing the interrupt by the selected processor within the mode such that the processors other than the selected processor operate normally without being affected by processing of the interrupt and without having to enter the mode.

18. The method of claim 17, further comprising:
determining whether the interrupt is of a particular type of interrupt; and,
where the interrupt is of the particular type, routing the interrupt to all the processors,
such that the interrupt is routed to only the selected processor where the interrupt is other than of the particular type.

19. The method of claim 17, wherein processing the interrupt by the selected processor comprises:
determining that another processor of the plurality of processors is to continue processing of the interrupt; and,
the selected processing routing the interrupt to the other processor.

20. An article of manufacture comprising:
a tangible computer-readable medium; and,
means in the medium for routing an interrupt to a selected processor of a plurality of processors for processing by the selected processor upon entry into a mode related to the interrupt, such that the processors other than the selected processor operate normally without being affected by the selected processor processing the interrupt and without having to enter the mode.
